(19) United States
(12) Patent Application Publication
(10) Pub. No.: US 2004/0057065 A1
(43) Pub. Date: Mar. 25, 2004

(54) Linking processing device, linking processing method, and recording medium containing linking processing program

(75) Inventors: Tadao Michimura, Kawasaki-shi (JP); Keiko Shiraishi, Kawasaki-shi (JP); Akira Hirose, Kawasaki-shi (JP); Tadahiko Ikegaya, Kawasaki-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/414,202

(22) Filed: Apr. 16, 2003

(30) Foreign Application Priority Data
Sep. 20, 2002 (JP) 2002-275231
Oct. 29, 2002 (JP) 2002-315024

(51) Int. Cl. B41F 1/00; G06F 15/00

(52) U.S. Cl. 358/1.13; 358/1.15

(57) ABSTRACT

A linking processing device includes a receiver and a controller. The receiver receives instruction information including a control content for linking and performing processing, on a network, of a plurality of services that each perform predetermined process of document data. The controller issues a request to each of the services for processing a document as a processing object, on the basis of the control content contained in the instruction information received by the receiver.

### BACKGROUND OF THE INVENTION

1. Field of the Invention

The present invention relates to a linking processing device, a linking processing method, and a recording medium containing a linking processing program. More specifically, the invention relates to a linking processing device, a linking processing method, and a recording medium containing a linking processing program that are suitably usable with a workflow system that structures a workflow by converting a hardcopy document into an electronic document.

2. Description of Related Art

Conventionally, workflow systems have been proposed in which machines such as a scanner, a facsimile machine, and photocopier or a multiple function device including these machines; a personal computer; and a mail server are interconnected via a network to implement the sharing of hardcopy documents and electronic information.

With recent advances in the Internet technology, Web services have been proposed that facilitate configuration of a higher-level work process by linking applications. Such Web services enable the applications on the network to be used as service components to facilitate configuration of a higher-level work-processing system. In addition, new services have been made by linking and/or combining these servers.

For an ordinary work process for a small amount of data, employing the above-described model (linkage of the services) without modification is feasible. However, in recent work, a large amount of data, such as image data, is handled, and the increment in the amount of data is excessively large in comparison to the network transfer rate.

For example, as disclosed in each of Japanese Patent Application Laid-Open (JP-A) Nos. 08-123744 and 2002-15106, in a system built into a configuration including centralized servers and user-side clients in order to implement a workflow, only display data is transferred to the clients. In this configuration, flexibility is low, and a work process is compelled to be structured only by combining a limited number of services. Namely, necessary functions need to be built into the servers in order to efficiently achieve functional enhancement.

JP-A No. 2001-282970 also discloses a workflow system. On the basis of the proposed workflow system, when a process on the client side is intensified to improve the flexibility, all data sets are transmitted to clients from a server. This is not feasible because a large amount of data is required to be handled. In addition, depending on the case, a large amount of data as a result of processing needs to be returned to the server after completion of processing, whereby the load on the network is even more increased. Thus, on the basis of the conventional art, while the process flow can be controlled, problems remain pending resolution in that no improvement can be achieved for data that is to be processed.

Since situations of the conventional arts are as described above, while workflows (regarding, for example, document circulation, small-deal decision, and approval) that are nonflexible and hence limited in applicability have been implemented, workflows of higher levels have not yet been realized.

### SUMMARY OF THE INVENTION

The present invention is proposed to solve the problems as described above, and has an object to provide a linking processing device, a linking processing method, and a recording medium containing a linking processing program that are capable of efficiently implementing linkage processes on a network.

A first aspect of the invention provides a linking processing device including: a receiver that receives instruction information including a control content for linking and performing processing, on a network, of a plurality of services that each perform predetermined process of document data to be linked and processed on network; and a controller that issues a request to each of the services for processing a document as a processing object, on the basis of the control content contained in the instruction information received by the receiver.

A second aspect of the invention provides a linking processing device including the steps of: receiving instruction information including control content for linking and performing processing, on a network, of a plurality of services that each perform a predetermined process for document; and issuing a request to each of the services for processing a document as a processing object, on the basis of the control content contained in the instruction information received by the receiver.

At first, each of the first and second aspects of the invention receives the instruction information. The instruction information includes the control contents for linking and performing processing, on a network, of the plurality of services to be linked and processed on the network. The service is not specifically limited as long as it performs a predetermined process for the document data; and the service corresponds to, for example, any one of a photocopy process, a print process, a scan process, a facsimile transmission/reception process, a mail distribution process, and an image process. Subsequently, the first and second aspects issue a request to each of the services for processing the document as the processing object, on the basis of the control content included in the instruction information received by the receiver. Consequently, the first and second aspects of the invention are able to control the plurality of services to be linked and processed on the network.

A third aspect of the invention provides a linking processing device for linking and processing, on a network, services that each perform a predetermined process for document data including first transmitting means that transmits first instruction information specifying a processing object and a first processing content for the processing object, to a first service processing device; receiving means that receives a processing result of processing performed by the first service processing device; and second instruction information specifying the processing object processed by the first service processing device, and second transmitting means that transmits the second instruction information and a second processing content to a second service processing device.

The third aspect of the invention relates to a linkage process in which services that each perform a predetermined process for document data are linked and processed on a network. The document data is not specifically limited, but may be any information relating to a document, such as character information of text data and the like and image information read out from a hardcopy document.

The first transmitting means transmits first the instruction information specifying the processing object and the first processing content for the processing object, to a first service processing device. The first transmitting means executes a predetermined process for the processing object; and it is not limited to a type configured of hardware, but may be a module (software). The first transmitting means transmits first instruction information and the first processing content that specifies the process execution to the first service processing device.

The receiving means receives the processing result of processing performed by the first service processing device and the second instruction information specifying the processing object processed by the first service processing device. Thereby, processing state in the service processing device is acquired, and subsequent processing content is determined in consideration of the linkage process of the services. The second transmitting means transmits the second instruction information and the second processing content to the second service processing device.

Thus, on the basis of the third aspect of the invention, the instruction information specifying the processing object and the processing content for the processing object are transmitted, and the processing result and the instruction information for specifying the processing object are received. Thereby, the flow operation and each of the service processing device are arranged independent of each other to minimize the frequency of direct transmissions/receptions of the processing object. Consequently, the processes can be executed at high speed.

In the third aspect of the invention, the first instruction information and the second instruction information preferably include document information, or a storage location for the document and a method of acquiring the document.

In the case where the first and second instruction information include the document information, the first and second transmitting means perform directly transmission of the document information to the respective first and second service processing devices. In the case where the first and second instruction information include the information of the storage of the document and the acquiring method for the document, the first and second transmitting means need not perform the direct transmission of the processing object. Thereby, the third aspect of the invention minimizes the transfer amount of data on the network, thereby enabling high-speed processing to be implemented.

Preferably, the third aspect of the invention further includes first determining means that determines the second processing content on the basis of the processing result received by the receiving means. In this case, the third aspect of the invention determines the second processing content for the subsequent service process on the basis of the result of processing performed by the first service processing device. Therefore, the third aspect is able to flexibly determine subsequent-stage processing content upon receipt of the previous-stage processing result.

Preferably, the third aspect of the invention further includes second determining means that determines the second processing content that is processed by the second service processing device and a third processing content that is processed by a third service processing device that subsequently performs processing, on the basis of the processing result received by the receiving means. In this case, the third aspect of the invention determines the second processing content that is to be processed by the second service processing device and the third processing content that is to be processed by the third service processing device, on the basis of the result of processing performed by the first service processing device. Therefore, the third aspect is able to flexibly determine the subsequent processing content and a processing content after the subsequent process upon receipt of the previous-stage processing result.

Preferably, the third aspect of the invention further includes third determining means that determines the third processing content that is processed by the third service processing device, on the basis of the processing result received by the receiving means and a processing result of processing performed by the second service processing device. Accordingly, the third aspect of the invention determines the third processing content for the subsequent process that is to be processed by the third service processing device, on the basis of the result of processing performed by the first service processing device and the result of processing performed by the second service processing device. Therefore, the third aspect is able to flexibly determine the third processing content upon receipt of the two previous-stage processing results.

A fourth aspect of the invention provides a linking processing method for linking and processing, on a network, services that each perform a predetermined process for document data including a first transmitting step for transmitting first instruction information specifying a processing object and a first processing content for the processing object, to a first service processing device; a receiving step for receiving a processing result of processing performed by the first service processing device and second instruction information specifying the processing object processed by the first service processing device; and a second transmitting step for transmitting the second instruction information and a second processing content to a second service processing device.

A fifth aspect of the invention provides a recording medium containing a linking processing program for linking and processing, on a network, services that each perform a predetermined process for document data thereon. The linking processing program directing a computer to execute processing includes a first transmitting step for transmitting first instruction information specifying a processing object and a first processing content for the processing object, to a first service processing device, a receiving step for receiving a processing result of processing performed by the first service processing device and second instruction information specifying the processing object processed by the first service processing device, and a second transmitting step for transmitting the second instruction information and a second processing content.

Thus, on the basis of any one of the third to fifth aspects of the invention, the instruction information specifying the processing object and the processing content for the processing object are transmitted, and the processing result and the instruction information for specifying the processing object are received. Thereby, the flow operation and each of the service processing device are arranged independent of each other. Consequently, the processes can be executed at high speed.

A sixth aspect of the invention provides a linking processing device including: a controller that generates discrete instruction information including at least one of instruction information for the document data and processing-related information therefor with respect to the service whose turn in a linkage process has arrived, on the basis of linkage instruction information instructing linking and processing, on a network, of a plurality of services that each perform a predetermined process for document data; a transmitter that transmits the discrete instruction information to a service processing device that carries out the service in its turn for the linkage process; and a receiver that receives the instruction information for the document data processed by the service processing device and a processing result of processing performed by the service processing device.

In the sixth aspect of the invention, the controller may generate the discrete instruction information on the basis of at least one processing result received by the receiver, for at least one service whose turn in the linkage process comes next or thereafter.

In addition, in the sixth aspect of the invention, the controller may determine a subsequent service and may generate the discrete instruction information for the determined service on the basis of linkage processing information including condition-branching linkage processing, and at least one processing result received by the receiver.

Further, in the sixth aspect of the invention, the instruction information for the document data may be information representing a storage location for the document data or a method of acquiring the document data.

A seventh aspect of the invention provides a recording medium containing a linking processing program directing a computer to execute the process comprising: generating discrete instruction information including at least one of instruction information for the document data and processing-related information therefor with respect to the service whose turn in a linkage process has arrived, on the basis of linkage instruction information instructing linking and processing, on a network, of a plurality of services that each perform a predetermined process for document data; transmitting the discrete instruction information to a service processing device that carries out the service in its turn for the linkage process; and receiving the instruction information for the document data processed by the service processing device and a processing result of processing performed by the service processing device.

### BRIEF DESCRIPTION OF THE DRAWINGS

FIG. 1 is a block diagram of the configuration of a document processing system on the basis of a first embodiment of the present invention.

FIG. 2 is a block diagram of the configurations of a multiple function device, a service search server, an instruction sheet editor, an instruction sheet management server, and a linking processing server of the document processing system.

FIG. 3 is a view of the configuration of I/F information stored in an I/F information memory.

FIG. 4 is a view of an instruction sheet editor screen displayed in a graphical user interface (GUI) of an instruction sheet editor.

FIG. 5 is a view of the configuration of an instruction sheet made by an instruction sheet making section.

FIG. 6 is a view of the configuration of a first service processing device.

FIG. 7 is a view of the configuration of a second service processing device.

FIG. 8 is a view of an example instruction sheet list screen showing a list of instruction sheets displayed in a GUI 14 of the multiple function device.

FIG. 9 is a view of an example instruction sheet screen displayed upon selection of a “COMMUNICATION WITH MANAGER” button.

FIG. 10 is a view of an example instruction sheet screen displayed following selection of a “WRITING INTO HP” button.

FIG. 11 is a flowchart showing steps of a linkage process of the document processing system.

FIG. 12 is a block diagram of a document processing system on the basis of a second embodiment of the invention.

FIG. 13 is a block diagram of the configurations of a client terminal, a service search server, an instruction sheet generation server, an instruction sheet management server, a linking processing server, an image processing device, a document management server, a document distribution server, a first service processing device, and a second service processing device of the document processing system.

FIG. 14 is a flowchart showing steps of a linkage process of the document processing system.

### DESCRIPTION OF THE PREFERRED EMBODIMENTS

Hereinbelow, preferred embodiments of the invention will be described with reference to the drawings.

[First Embodiment]

(System Configuration)

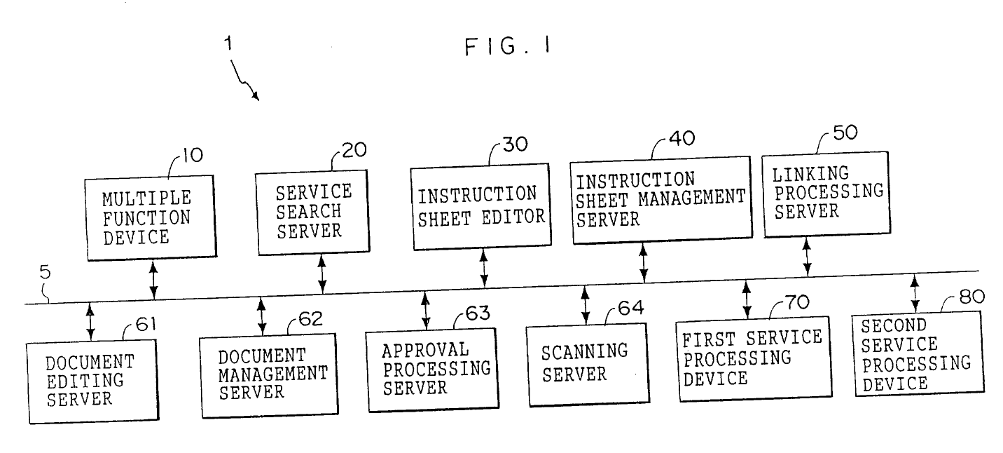

FIG. 1 is a block diagram of the configuration of a document processing system 1 according to a first embodiment of the invention.

The document processing system 1 is configured such that, for example, various services and applications are connected via a network 5. The terminology “service” used herein refers to a document-related function usable in response to a request received from an external source. Specifically, the service correspond to any one of functions such as those for a photocopying process, a printing process, a scanning process, a facsimile transmission/reception process, a mail distribution process, a process of storing data into a repository, a process of reading data out of the repository, an OCR (optical character recognition) process, and a noise-erasing process.

More specifically, the document processing system 1 includes a multiple function device 10 for performing such service processes as photocopy, print, scan, and facsimile communication processes; a service search server 20 for searching a service desired by a user; an instruction sheet editor 30 for serving as a client terminal to and for making instruction sheets; an instruction sheet management server 40 for managing the instruction sheets; and a linking processing server 50 for an executing linkage process for individual services on the basis of the instruction sheet.

In addition, the document processing system 1 includes a document editing server 61 having a document editing function, a document management server 62 for managing documents, an approval processing server 63 having an approval processing function, a scanning server 64 for scanning hardcopy documents, a first service processing device 70 for performing a first service process, and a second service processing device 80 for performing a second service process.

The service processing devices are not specifically limited, but may be a photocopier, a facsimile machine, a multiple function device, a server, and a computer that performs predetermined processes for document data. Each of the service processing devices is controlled by a predetermined control program. The program may be of a type downloaded via a computer-usable medium such as a network or be of a type recorded in a computer-readable recording medium such as an optical disk or a magnetic disk.

Either the document processing system 1 of the first embodiment or a document processing system of a second embodiment is configured such that a plurality of servers for carrying out predetermined service processes are interconnected via the network 5. However, as long as the plurality of services are interconnected via a network as the network 5, no other specific restrictions are placed.

In a case where a series of processes is separated into a plurality of functional processes, the “instruction sheet” is data made by integrating information representing relations of individual functions, interface (I/F) information for invoking the individual functions, and information regarding a graphical user interface (GUI) related to the series of processes. The structure of the instruction sheet will be described in detail in later sections.

The “linkage” refers to an interservice relationship in which, for example, a result of a service determines services that will be subsequently invoked or influences operations of the subsequent services.

The multiple function device 10 is a service processing device that performs four services: photocopy, print, scan, and facsimile communication services. As described above, the service processing devices are not specifically limited, but may be a photocopier, a facsimile machine, a multiple function device, a server, and a computer that performs predetermined processes for document data. The multiple function device 10 further includes a linkage invocation function. With this function, an instruction sheet is selected, parameters are input, and a request is issued for the invocation of a linkage process reflecting the input parameters in the instruction sheet.

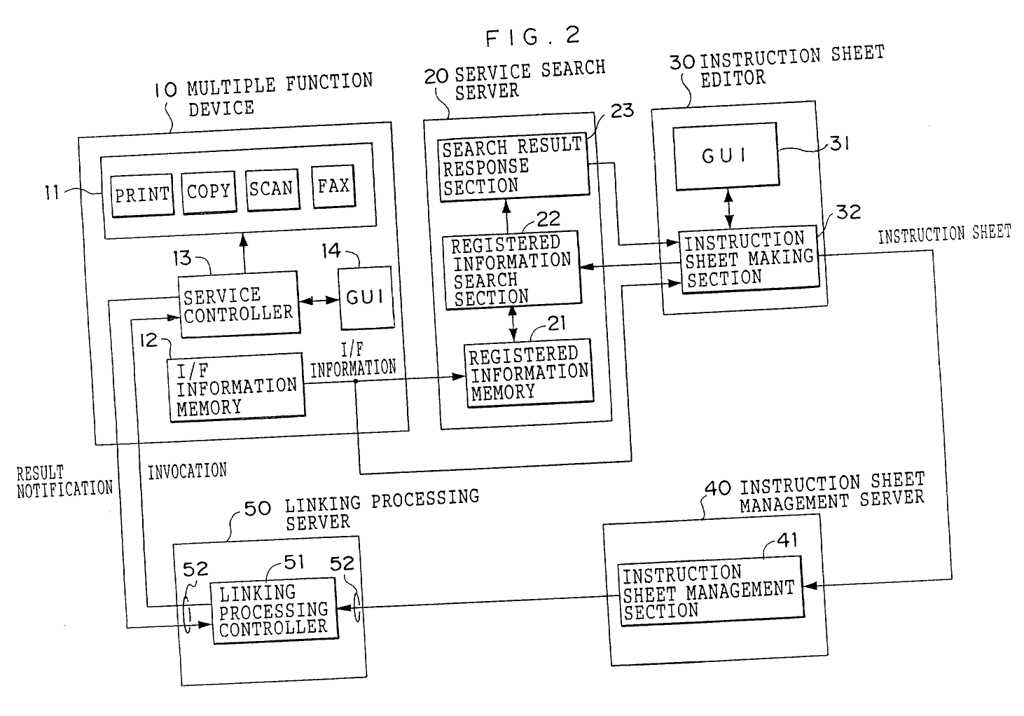

FIG. 2 is a block diagram of the configurations of the multiple function device 10, the service search server 20, the instruction sheet editor 30, the instruction sheet management server 40, and the linking processing server 50 of the document processing system 1.

The multiple function device 10 includes a service providing section 11 for performing photocopy, print, scan, and facsimile communication processes as service processes; an I/F information memory 12; a service controller 13 for controlling the service providing section 11; and a graphical user interface 14 (GUI). The GUI 14 is configured to include, for example, a touch panel and buttons, and is used to perform predetermined operations such as display of instruction sheets and others.

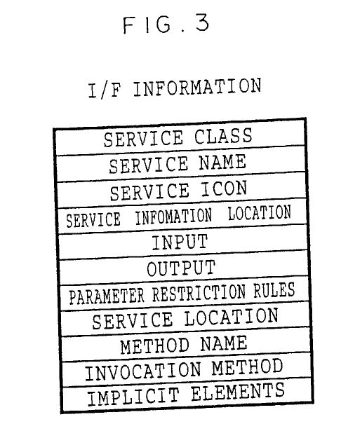

FIG. 3 is a view of the configuration of the I/F information stored in the I/F information memory 12. The I/F information is configured of information under the entries <Service Class>, <Service Name>, <Service Icon>, <Service Information Location>, <Input>, <Output>, <Parameter Restriction Rules>, <Service Location>, <Method Name>, <Invocation Scheme>, and <Implicit Elements>.

<Service Class> declares the class of services provided by the multiple function device 10 that works as a service processing device. As parameters of <Service Class>, parameters predefined are used. The parameters correspond to, for example, scan, print, repository, and flow services.

<Service Name> declares the names of services provided by the multiple function device 10. <Service Icon> declares the position of icons that are displayed in the GUI 31 of the instruction sheet editor 30.

<Service Information Location> declares a URL that the service search server 20 uses to search the I/F information. <Input> declares input to the services. <Output> declares output to the services.

<Parameter Restriction Rules> declares a restriction rule(s) defined in, for example, <Input> and/or <Output>. <Method Name> declares a provision method of the service processes.

<Invocation Scheme> declares a scheme for invoking the service processes. As a scheme to be declared in <Invocation Scheme>, for example, a message communication protocol such as the SOAP (Simple Object Access Protocol) or the STMP (Simple Mail Transfer Protocol) may be used.

<Implicit Elements> declares data that can be referenced in a subsequent-stage process while the data is not explicitly transferred as an output to the subsequent-stage process. The other service processing devices, such as the servers, also have I/F information similar to that shown in FIG. 3.

The multiple function device 10 performs, for example, registration of part of I/F information stored in the I/F information memory 12 into the service search server 20 and transmission of I/F information to the instruction sheet editor 30 in response to a request received from the instruction sheet editor 30.

The service controller 13 controls the GUI 14 to display a list of instruction sheets that has been transmitted from the instruction sheet management server 40 via the linking processing server 50. In addition, in an event where, for example, an instruction sheet is selected through the GUI 14 or parameters are input therethrough, the service controller 13 performs control so that the contents of the parameters are reflected in the instruction sheet and so that the service providing section 11 performs an executable process in the above-described environment. Upon termination of the process executed by the service providing section 11, the service controller 13 transmits the execution result and the instruction sheet to the linking processing server 50.

The service search server 20 searchs a desired service from registered I/F information in response to a request received from the instruction sheet editor 30. Specifically, as shown in FIG. 2, the service search server 20 includes a registered information memory 21 for storing I/F information registered by the service processing devices of the multiple function device 10, a registered information search section 22 for searching a desired service by using information registered into the registered information memory 21, and a search result response section 23 for performing a response process to the search result.

The instruction sheet editor 30 serves as a client terminal and has an instruction sheet making function. Specifically, as shown in FIG. 2, the instruction sheet editor 30 includes a GUI 31 through which, for example, operations are performed by a user, and a list of services is displayed; and an instruction sheet making section 32 for making instruction sheets.

In addition, the GUI 31 is used, for example, to search a desired service and to make a workflow. Further, the GUI 31 displays information of various types including a service list showing search results of the service search server 20; usage methods for the document editing server 61, the approval processing server 63, and the document management server 62; and linkage-process pattern information preserved in the instruction sheet editor 30. Furthermore, the GUI 31 is used as a client terminal to input, for example, predetermined parameters.

The instruction sheet making section 32 makes an instruction sheet on the basis of user operations of the GUI 31 and outputs the instruction sheet in the form of an XML (Extensible Markup Language) file. The instruction sheet includes the definitions of usage-time display contents, input parameters, and a linkage method (workflow) for a series of the document-editing service, the approval process service, and the document management service.

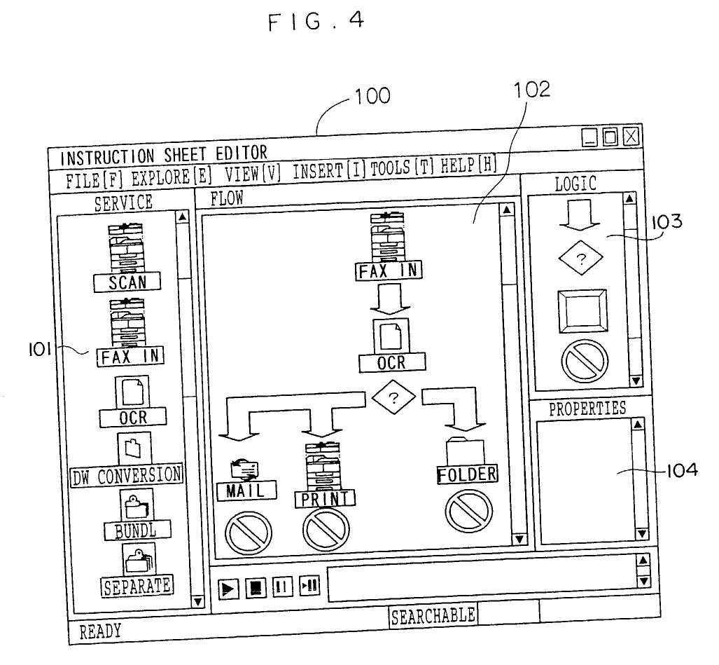

FIG. 4 is a view of an instruction sheet editor screen 100 displayed in the GUI 31 of the instruction sheet editor 30. The instruction sheet editor screen 100 is basically configured of a services window 101, a flow window 102, a logic window 103, and a property window 104.

The services window 101 displays various services of, for example, the multiple function device 10. The logic window 103 displays a workflow of an interservice linkage pattern. The property window 104 displays detailed setting parameters for individual icons that are displayed on the services window 101 and the logic window 103.

The instruction sheet making section 32 searches a service list showing outlines of usable services from the service search server 20. In addition, using the information in the entry of <Service Information Location>regarding each of the service processing devices, which is described in the service list, the section 32 searches I/F information indicative of a service usage method from each of the service processing devices. Then, on the basis of the search information, the instruction sheet making section 32 displays the services window 101 and the property window 104 in the GUI 31.

For a user to make a workflow, it is sufficient that the user drags and drops the icons shown in the services window 101 and the icons shown in the logic window 103 in the flow window 102 by operating the GUI 31. In response to the operations performed through the GUI 31, the instruction sheet making section 32 assembles a linkage of services and makes an instruction sheet.

In addition, by operating the GUI 31, the user is able to select desired icons and to edit the contents displayed on the property window 104 to set corresponding services, logics, and the like in detail.

The instruction sheet editor 30 makes the instruction sheet in the form of an XML format file, and transmits the made instruction sheet to the instruction sheet management server 40.

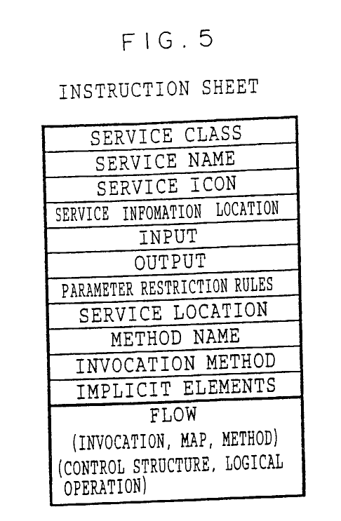

FIG. 5 is a view of the configuration of an instruction sheet made by the instruction sheet making section 32. The instruction sheet includes an entry entitled <Flow> in addition to those that configure the I/F information shown in FIG. 3.

<Flow> is an element in which an interservice linkage, and includes other elements such as<Invoke> and <if> that are provided to represent control structures, logical operations, and calculations.

<Invoke> represents specific methods of the service processing devices and invokes the services. The <Invoke>elements include <Map> representing parameter position information and <Method> representing a method to be invoked. The elements <if>, <and>, <eq>, and <gt>individually execute condition-branching operations when performing a linkage process and adjust parameters passed between services.

The instruction sheet describes all the information regarding control of service linkage processes in the form of the <Flow> element. Thereby, also the linkage process itself indicated in the instruction sheet is recognized as a service. For this reason, as described above, the instruction sheet contains information having the same content of that of the I/F information of one of the other service processing devices.

The instruction sheet management server 40 includes an instruction sheet management section 41 for managing instruction sheets. The instruction sheet management section 41 preserves the instruction sheet transmitted from the instruction sheet editor 30 and transmits instruction sheet to, for example, the multiple function device 10 and the linking processing server 50 in response to requests therefrom.

The linking processing server 50 includes a linking processing controller 51 for interpreting and executing a specified instruction sheet and a transmitting/receiving unit 52 for transmitting or receiving information. Upon receipt of the transmitted instruction sheet, the linking processing controller 51 interprets the instruction sheet, invokes, for example, a predetermined service processing device, the document editing server 61, and the document management server 62, and the approval processing server 63, and controls a linkage process therefor to be executed. In addition, the linking processing server 50 preserves state information of the linkage process in process and the result of the completed linkage process, and reports the information of the state, result, and the like of the linkage process in response to a request from an external source.

In response to a request from the linking processing server 50, the document editing server 61 controls the GUI 31 of the instruction sheet editor 30 (client terminal) to display a document edit screen, and executes the document editing function on the basis of operations performed on the document edit screen. In addition, at power-on, the document editing server 61 posts part of I/F information to the service search server 20. Further, in response to a request from the instruction sheet editor 30, the document editing server 61 transmits I/F information indicating a usage method for the document-editing service.

The document management server 62 includes a document storage function. In response to a request from the linking processing server 50, the document management server 62 displays a document management screen through the GUI 31 of the instruction sheet editor 30 (client terminal), and executes the document storage function on the basis of operations performed on the document management screen. In addition, at power-on, the document management server 62 posts part of I/F information to the service search server 20. Further, in response to a request from the instruction sheet editor 30, the document management server 62 transmits I/F information indicating a usage method for the document management service.

In response to a request from the linking processing server 50, the approval processing server 63 displays an approval screen through the GUI 31 of the instruction sheet editor 30 (client terminal), and executes an approval process on the basis of operations performed on the approval screen. In addition, at power-on, the approval processing server 63 posts part of I/F information to the service search server 20. Further, in response to a request from the instruction sheet editor 30, the approval processing server 63 transmits I/F information indicative of a usage method for the approval process service.

The scanning server 64 has functions of scanning a hardcopy document, generating scan data, transmitting the scan data by mail to an arbitrary address, and preserving the scan data an arbitrary location. In response to a request from the linking processing server 50, the scanning server 64 displays a scan process screen through the GUI 31 of the instruction sheet editor 30 (client terminal), and executes a scan process on the basis of operations performed on the scan process screen. In addition, at power-on, the scanning server 64 posts part of I/F information to the service search server 20. Further, in response to a request from the instruction sheet editor 30, the scanning server 64 transmits I/F information indicating a usage method for the scan process service.

The first service processing device 70 performs a predetermined service process regarding a document on the basis of an instruction issued from an external source. In response to a request from the linking processing server 50, the first service processing device 70 displays a scan process screen through the GUI 31 of the instruction sheet editor 30, and executes a service process on the basis of operations performed on the service process screen. In addition, at power-on, the first service processing device 70 posts part of I/F information to the service search server 20. Further, in response to a request from the instruction sheet editor 30, the first service processing device 70 transmits I/F information indicating a usage method for the service process.

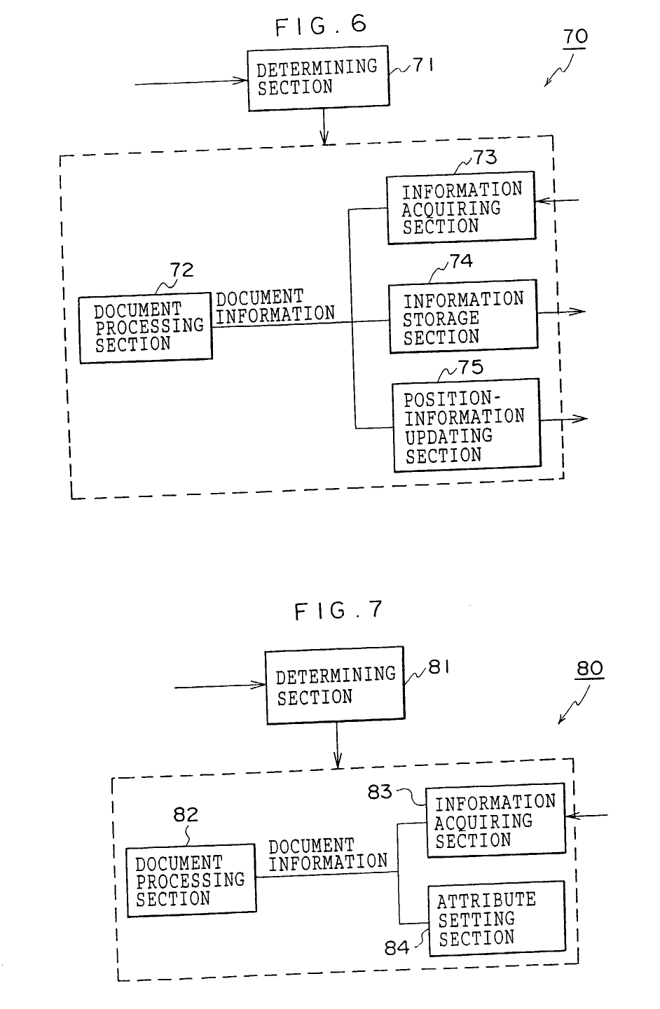

FIG. 6 is a view of the configuration of the first service processing device 70. The first service processing device 70 includes a determining section 71 for determining the necessity of document information, a document processing section 72 for performing document processes, an information acquiring section 73 for acquiring document information from the network 5, an information storage section 74 for storing document information on the network 5, and a position-information updating section 75 for updating document information.

The second service processing device 80 performs services for processing attributes of documents in response to instructions received from external sources. In response to a request from the linking processing server 50, the second service processing device 80 displays a service process screen through the GUI 31 of the instruction sheet editor 30, and executes a service process on the basis of operations performed on the service process screen. In addition, at power-on, the second service processing device 80 posts part of I/F information to the service search server 20. Further, in response to a request from the instruction sheet editor 30, the second service processing device 80 transmits I/F information indicating a usage method for the service process.

FIG. 7 is a view of the configuration of the second service processing device 80. The second service processing device 80 includes a determining section 81 for determining the necessity of document information, a document processing section 82 for performing document processes, an information acquiring section 83 for acquiring attributes from the network 5, and an attribute setting section 84 for setting attributes.

The document processing system 1 configured as described above operates as described below upon installation of an application program for executing each service into, for example, the document editing server 61, the document management server 62, and the approval processing server 63.

After the installation of the program, the document editing server 61, the document management server 62, and the approval processing server 63 each post to the service search server 20 information indicating an outline of each of the services and the address. Specifically, each of these servers posts part of the I/F information (such as those for the entries of <Service Class>, <Service Name>, <Service Information Location>, <Input>, and <Output>). However, the arrangement may be modified such that the overall I/F information is posted therefrom to the service search server 20.

The registered information memory 21 of the service search server 20 preserves the information transmitted from the document editing server 61, the document management server 62, and the approval processing server 63.

(Instruction sheet Making Process)

According to a request from a user, the instruction sheet editor 30 makes an instruction sheet which defines a service linkage. More specifically, upon start of user operations for defining a service linkage through the GUI 31, the instruction sheet making section 32 of the instruction sheet editor 30 issues a request to the service search server 20 for a service list indicating usable services. Upon receipt of a service list indicating a search result and information under <Service Information Location> transmitted from the service search server 20, the instruction sheet making section 32 displays a list of the services in the GUI 31.

In addition, using the information under <Service Information Location>, the instruction sheet making section 32 directly acquires I/F information from corresponding service processing devices. In this case, if the service search server 20 has I/F information of all the service processing devices, the instruction sheet making section 32 may request for the I/F information preserved in the service search server 20, and may preserve the results.

Upon definition carried out by the user through the GUI 31 to establish a desired service linkage, the instruction sheet making section 32 makes an instruction sheet indicating linkage-flow information, GUI-displayed information at linkage invocation time and linkage in-progress time, and I/F information for each of the services in the form an XML format file. Subsequently, the instruction sheet making section 32 transmits the thus-made instruction sheet to the instruction sheet management server 40.

The instruction sheet management section 41 of instruction sheet management server 40 preserves the instruction sheet transmitted from the instruction sheet editor 30.

(Invocation of Linkage Process)

The multiple function device 10 is capable of invoking a linkage process. Specifically, in response to operations performed through the GUI 14, the service controller 13 of the multiple function device 10 requests the instruction sheet management server 40 for instruction sheets, and controls a list of instruction sheets transmitted from the instruction sheet management server 40 to be displayed in the GUI 14.

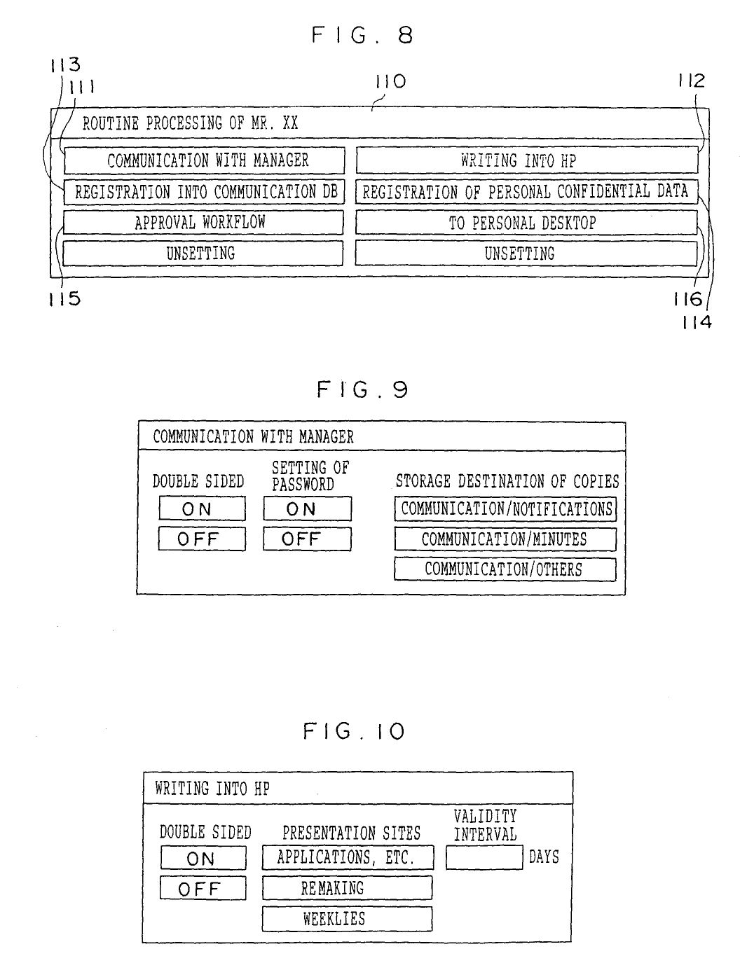

FIG. 8 is a view of an example instruction sheet list screen 110 showing listed information in an instruction sheet displayed in the GUI 14. The instruction sheet list screen 110 includes buttons for selecting instruction sheets to be displayed. For example, the instruction sheet list screen 110 includes a “COMMUNICATION WITH MANAGER” button 111, a “WRITING INTO HP (homepage)” button 112, a “REGISTRATION INTO COMUNICATION DB” button 113, a “RESISTRATION OF PERSONAL CONFIDENTIAL DB” button 114, an “APPROVAL WORKFLOW” button 115, and a “TO PERSONAL DESKTOP” button 116.

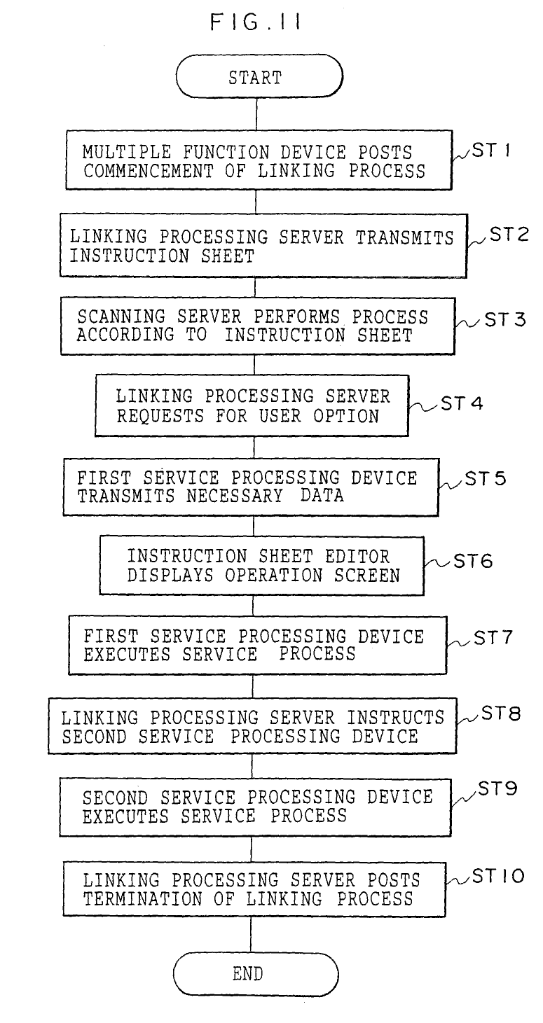

FIG. 9 is a view of an example instruction sheet screen displayed upon selection of the “COMMUNICATION WITH MANAGER” button 111. FIG. 10 is a view of an example instruction sheet screen displayed following selection of the “WRITING INTO HP” button 112.

In the stage described above, a user is able to select at least one of the instruction sheet buttons in the instruction sheet list screen 110 to further input necessary parameters by operating the GUI 14. For description given below, an instruction sheet selected by the user is assumed to be linkage information representing that the scanning server 64 is used to perform scanning of a hardcopy document, and the first service processing device 70 and the second service processing device 80 are individually used to perform predetermined processes for document information obtained through the scanning.

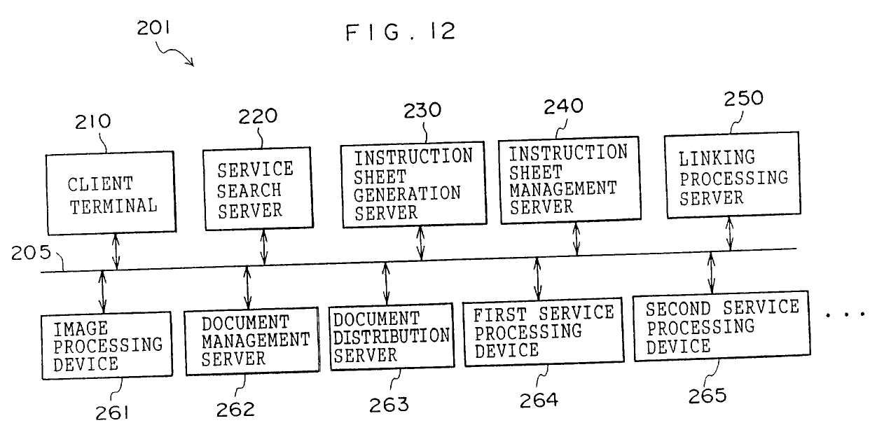

FIG. 11 is a flowchart showing steps of a linkage process of the document processing system. When a user has finally depresses a start button through the GUI 14, the document processing system 1 executes the linkage process on the basis of step ST1 and the subsequent processes (steps) shown in FIG. 11.

In step ST1, the multiple function device 10 reports to the linking processing server 50 of the commencement of the linkage process.

In step ST2, on the basis of the instruction sheet selected by the user, the linking processing server 50 instructs the scanning server 64 to perform scanning of a hardcopy document, and instructs the first service processing device 70 to store an image document and attribute information thereof.

In step ST3, in response to the instruction from the linking processing server 50, the scanning server 64 scan the hardcopy document and creates an image document. After the image document and the attribute information thereof have been stored into the first service processing device 70, the processing result and the processed document information are posted to the linking processing server 50.

In step ST4, the linking processing server 50 instructs the first service processing device 70 to transmit position information of necessary data and the content of the process to the user and to request options of the user.

In step ST5, the first service processing device 70 performs processes described hereunder in order to request options of the user. The determining section 71 of the first service processing device 70 determines all data (document information and position information of document information serving as other reference information) that is necessary for display. When the necessary document information is preserved in the document management server 62, the information acquiring section 73 acquires only the necessary document information from the document management server 62. The first service processing device 70 transmits all the necessary data thus acquired to the instruction sheet editor 30 (client terminal).

In step ST6, upon receipt of the data from the first service processing device 70, the instruction sheet editor 30 displays an operation screen in the GUI 31 on the basis of the above-described data, thereby requesting for options of the user. When the user has entered determined options by operating the GUI 31, the instruction sheet editor 30 posts the determined user options to the first service processing device 70.

In step ST7, upon acquiring of the resultant user options determined as described above, the first service processing device 70 performs the service process on the basis of the determined options.

For example, when the document information to be used as an object is available on the network 5, the information acquiring section 73 acquires the necessary document information and the like from the network 5 and transmits the acquired document information to the document processing section 72. The document processing section 72 invokes predetermined services on the basis of, for example, the processing content transmitted from the linking processing server 50, and performs the predetermined document process for the document information acquired by the information acquiring section 73.

In addition, with reference to the instruction sheet, the determining section 71 compares an information acquiring cost in the subsequent step (cost required for reacquiring the document information after the information is returned to the original storage area when the process proceeds to the subsequent service step) with a position-information updating cost in the subsequent service step (cost required for updating only the position information of the instruction sheet when the process proceeds to the subsequent service step). Then, for example, the determining section 71 performs write-back of the document information to the original allocated storage area and updates the position information of the document information to reduce the cost. If the determining section 71 has determined that the document information, which is the processing object, can be processed in the document processing section 72 from the beginning, the determining section 71 requests the document processing section 72 to execute the processing of the above-described document.

Upon termination of the service processes described above, the first service processing device 70 posts to the linking processing server 50 processing results and instruction information indicative of the processed-document information to the linking processing server 50.

In step ST8, the linking processing server 50 determines the processing content of the second service processing device 80 by using the processing result posted from the first service processing device 70. Then, the linking processing server 50 transmits position information of necessary data and the determined processing content as process direction to the second service processing device 80.

According to the position information that has been transmitted as described above, the linking processing server 50 is capable of not only determining the processing content of the second service processing device 80, but also determining the content of a subsequent process when necessary on the basis of the processing result of the first service processing device 70.

In step ST9, the second service processing device 80 performs processes described hereunder on the basis of the position information that has been transmitted as described above. Specifically, according to the transmitted position information, the determining section 81 determines the position of the document information stored in the document management server 62. The information acquiring section 83 acquires attributes of the document information stored in the document management server 62. The attribute setting section 84 sets the attributes of the document information stored in the document management server 62. Through theses processes, the second service processing device 80 posts to the linking processing server 50 the result of the changed setting of the attributes and the processed document.

In step ST10, upon receipt of the processing result and the processed document that have been posted from the second service processing device 80, the linking processing server 50 posts a linkage-process completion result to the multiple function device 10 which has been notified of the linkage-process commencement. When a subsequent service process is required, the linking processing server 50 may be controlled to determine the content of the subsequent service process on the basis of the processing results of the first service processing device 70 and the second service processing device 80.

As described above, on the basis of the instruction sheet used for executing the workflow, the document processing system 1 transmits the position information of the document selected as a processing object and the service processing results to the service processing devices. In this manner, the document processing system 1 enables transfers of large amounts of document information to be minimized and enables high-speed linkage processes in the overall system to be implemented.

More specifically, on the basis of the document processing system 1, the workflow control and the discrete service processes are independently configured, and a series of processes is executed through a dynamic linkage. Thereby, the document and other data to be referenced need not be transferred around in the network, and document and other data necessary for service processes are acquired depending on the necessity. Consequently, high-speed linkage processes can be implemented.

The invention is not limited to the embodiment described above, but various design modifications may be practiced within the spirit and scope of the appended claims.

For example, the document storage function and services that directly perform document processes may be built into an integrated unit. Thereby, the number of document transfers is reduced to enable the implementation of high-speed linkage processes.

The instruction-sheet storage may be provided as a service. Thereby, one instruction sheet can be shared.

Exchange of data necessary for services among input/process/output datasets may be preliminarily described in an instruction. Thereby, the installation of the services can be simplified. Further, while the processes are fixed, efficiencies of the service processes can be improved.

In stead of the optimizations of information transfers that are discretely implemented through the services, the optimizations may be implemented in such a manner that the contents and positions of processes in the overall system are searched, the processing sequence thereof is changed, and the processes are thereby parallelized so as to minimize the information transfer costs. This arrangement enables efficiencies of the processes in the overall system to be improved.

In addition, the configuration may be modified such that the instruction sheet including an instruction sheet is made, and the service processing devices function as linking processing server 50. In this case, since a complicated linkage process is separated and managed, the maintenance thereof can be facilitated.

Further, the configuration may be modified such that both the processing content and processing object are presented, a determination is made as to whether one or more services can be performed on the basis of the presented information; and if the services are determined to be performable, the services are implemented in that manner. Thereby, failure-with standability can be improved, and the processes can be parallelized.

In the above, the embodiment has been described with reference to the example in which the multiple function device 10 has the linkage invocation function. However, the scanning server 64 or one of the other servers may instead have the linkage invocation function. In addition, although the instruction sheet editor 30 functions as a client terminal in the present embodiment, an independent client terminal may be provided in the network or one of the servers may have the function of the client terminal.

[Second Embodiment]

(System Configuration)

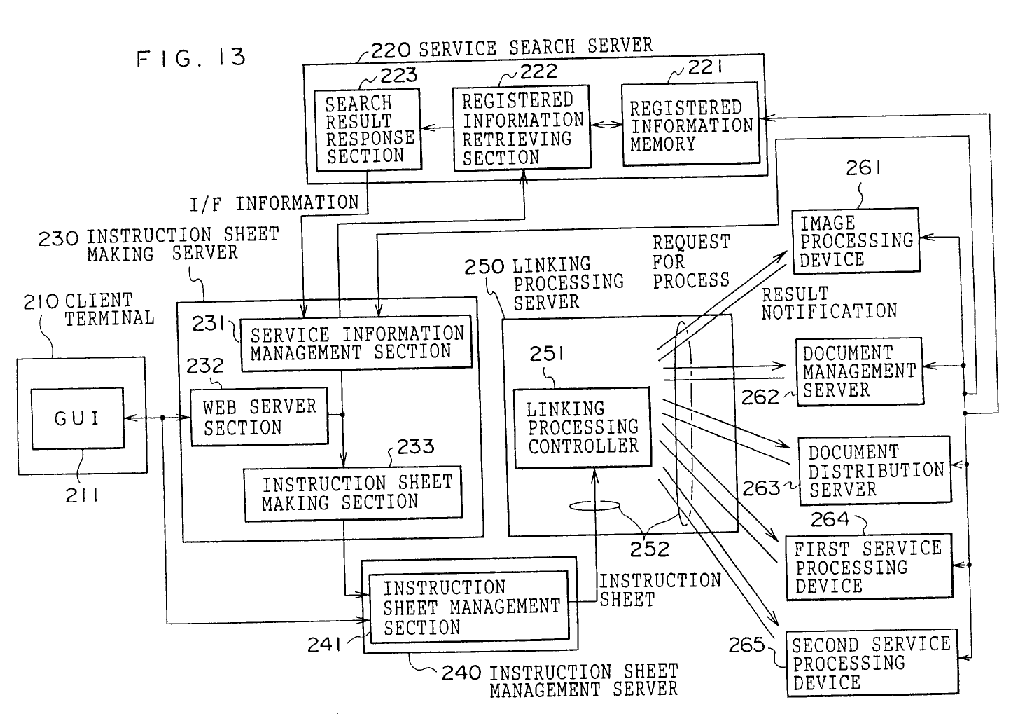

FIG. 12 is a block diagram of the configuration of a document processing system 201 on the basis of a second embodiment of the invention.

The document processing system 201 is configured such that, for example, various services and applications, are interconnected via a network 205.

The document processing system 201 includes a client terminal 210 including a user interface that allows a plurality of services to be linked and that issue instructions for processes desired by a user, a service search server 220 for searching a service desired by the user, an instruction sheet making server 230 for making instruction sheets individually from information regarding a service linkage instructed by a client terminal, an instruction sheet management server 240 for managing the instruction sheets, and a linking processing server 250 for executing a linkage process for individual services on the basis of the instruction sheet.

In addition, the document processing system 201 includes an image processing device 261 for performing image processes such as a noise erasing process for an image document, an image rotating process, an OCR process, and an image binding process; a document management server 262 for managing documents; a document distribution server 263 for distributing documents; a first service processing device 264 for performing a first service process, and a second service processing device 265 for performing a second service process.

In the second embodiment, the document processing system 201 is configured such that a plurality of servers for carrying out predetermined service processes are interconnected via the network 205. However, as long as a plurality of services are interconnected via the network 205, no other specific restrictions are placed.

In a case where a series of processes is separated into a plurality of functional processes, the “instruction sheet” mentioned above is data made by integrating information representing relations of individual functions, interface (I/F) information for invoking the individual functions, and information regarding a graphical user interface (GUI) related to the series of processes.

FIG. 13 is a block diagram of the configurations of the aforementioned configuration members of the document processing system 201. Namely, the configuration members are the client terminal 210, the service search server 220, the instruction sheet making server 230, the instruction sheet management server 240, the linking processing server 250, the image processing device 261 for performing various image processes for documents, the document management server 262 for managing documents, the document distribution server 263 for distributing documents, the first service processing device 264 for performing the first service process, and the second service processing device 265 for performing second service process.

The client terminal 210 includes a graphical user interface 211 (GUI). The GUI 211 is used, for example, to display images and to perform predetermined operations in order to provide instructions for making instruction sheets and others.

The service search server 220 searches a desired service from registered I/F information in response to a request received from the instruction sheet making server 230. Specifically, as shown in FIG. 13, the service search server 220 includes a registered-information memory 221 for storing I/F information registered from the service processing devices of the client terminal 210, such as the image processing device 261, the document management server 262, the document distribution server 263, the first service processing device 264, and the second service processing device 265; a registered information search section 222 for searching a desired service by using information registered into the registered-information memory 221; and a search result response section 223 for performing a response process to the search result.

Specifically, as shown in FIG. 13, the instruction sheet making server 230 includes a service information management section 231, a Web server section 232, and an instruction sheet making section 233.

The service information management section 231 performs, for example, issues a service search instruction to the service search server 220 and issues an acquiring request for service information, such as I/F information which is in possession of each of the services to each of the service processing devices distributed in the network 205. In addition, the service information management section 231 manages, for example, search results received from the service search server 220 and service information received from each of the service processing devices.

On the basis of service information under the management of the service information management section 231, the Web server section 232 generates an HTML file for a GUI screen that is used for workflow making. The GUI screen is preferably as the example screen having the layout shown in FIG. 4. In response to a viewing request from the client terminal 210, the Web server section 232 transmits the HTML file served as the generated GUI screen to the client terminal 210. The client terminal 210 transmits information indicated on the screen to the Web server section 232 as data having the CGI (common gateway interface) format.

The instruction sheet making section 233 makes the instruction sheet on the basis of information regarding a service-linkage instruction received by the Web server section 232 from the user, and information such as the I/F information regarding the individual services being the managed by the service information management section 231, and outputs the made instruction sheet in the form of an XML file. The instruction sheet thus made includes the definitions of information for specifying a document selected as a processing object. The aforementioned information includes, for example, the contents of processes that are requested to the individual services, input parameters, a linkage method (workflow) for the individual services, a document name, and storage-location information.

Through the processes described above, the instruction sheet making server 230 makes the instruction sheet in the form of an XML file. As in the first embodiment, the instruction sheet in this case is structured as shown in FIG. 5. The instruction sheet making server 230 transmits the instruction sheet to the instruction sheet management server 240. When execution of a service linkage process has been requested by the user, the instruction sheet making server 230 transmits the instruction sheet to the linking processing server 250.

The instruction sheet management server 240 includes an instruction sheet management section 241 for managing instruction sheets. The instruction sheet management section 241 preserves the instruction sheet transmitted from the instruction sheet making server 230, and transmits the instruction sheet to, for example, the client terminal 210 and the linking processing server 250 in response to requests therefrom.

The linking processing server 250 includes a linking processing controller 251 for interpreting and executing a specified instruction sheet and a transmitting/receiving unit 252 for transmitting or receiving information. Upon receipt of the instruction sheet that has been transmitted, the linking processing controller 251 interprets the instruction sheet, invokes a predetermined service processing device, the image processing device 261, the document management server 262, the document distribution server 263, and other service processing devices, and controls a linkage process therefor to be executed. In addition, the linking processing server 250 preserves state information of the linkage process in process and the result of the completed linkage process, and posts the information regarding the state, result, and the like of the linkage process in response to a request from an external source.

The linking processing controller 251 may be configured to interpret the instruction sheet received by the transmitting/receiving unit 252 and to thereby generate a discrete instruction sheet in units of each of the service processing devices when issuing a process request to each of the service processing devices. In this case, the instruction sheet may contain information such as for specifying a processing-request content, input parameters, and the document as a processing object. In addition, the transmitting/receiving unit 252 may be configured to make an instruction sheet containing descriptions of the relationships between the previous and subsequent processes and a current process that is processed by each of the service processing devices. Alternatively, the linking processing controller 251 may be configured to issue a process request using a discrete information exchange format instead of the instruction sheet format for each of the service processing devices.

The image processing device 261 is a computer including software programs for carrying out an image processing function. The image processing device 261 performs a document process on the basis of the service-process request content, input parameters, and information regarding the processing-objective document, which are included in the process request received from the linking processing server 250. In addition, upon activation, the image processing device 261 posts part of I/F information to the service search server 220. Further, in response to a request from the instruction sheet making server 230, the image processing device 261 transmits I/F information indicating a usage method for the image processing service.

The document management server 262 includes a document storage function. On the basis of information included in a request from the linking processing server 250, the document management server 262 executes various processing such as storage, search, and reading of the document, and changing the attribute of the document. In addition, upon activation, the document management server 262 posts part of I/F information to the service search server 220. Further, in response to a request from the instruction sheet making server 230, the document management server 262 transmits I/F information indicating a usage method for the document management service.

The document distribution server 263 has functions of, for example, performing mail transmission and facsimile transmission to an instructed transmission destination and performing a print-data output process to an instructed printer. In response to a request from the linking processing server 250, the document distribution server 263 performs a document distribution process on the basis of information regarding a document and a distribution destination, which have been instructed by the client terminal 210. In addition, upon activation, the document distribution server 263 posts part of I/F information to the service search server 220. Further, in response to a request from the instruction sheet making server 230, the document distribution server 263 transmits I/F information indicating a usage method for the document distribution processing service.

The first service processing device 264 performs a predetermined service process regarding a document on the basis of an instruction issued from an external source. On the basis of information such as a service-process request content, input parameters, and information for specifying the processing-objective document, which have been received from the linking processing server 250, the first service processing device 264 executes a service process assigned to itself. In addition, upon activation, the first service processing device 264 posts part of I/F information to the service search server 220. Further, in response to a request from the instruction sheet making server 230, the first service processing device 264 transmits I/F information indicating a usage method for the service process.

The document processing system 201 configured as described above operates as described below upon installation of an application program for executing each service into, for example, the image processing device 261, the document management server 262, and the document distribution server 263.

The devices such as the image processing device 261, the document management server 262, and the document distribution server 263 each post to the service search server 220 information indicating an outline of each of the services and the address—specifically, part of the I/F information (such as those for the entries of <Service Class>, <Service Name>, <Service Information Location>, <Input>, and <Output>). However, the arrangement may be modified such that the overall I/F information is posted therefrom to the service search server 220.

The registered-information memory 221 of the service search server 220 preserves the information transmitted from the image processing device 261, the document management server 262, and the document distribution server 263.

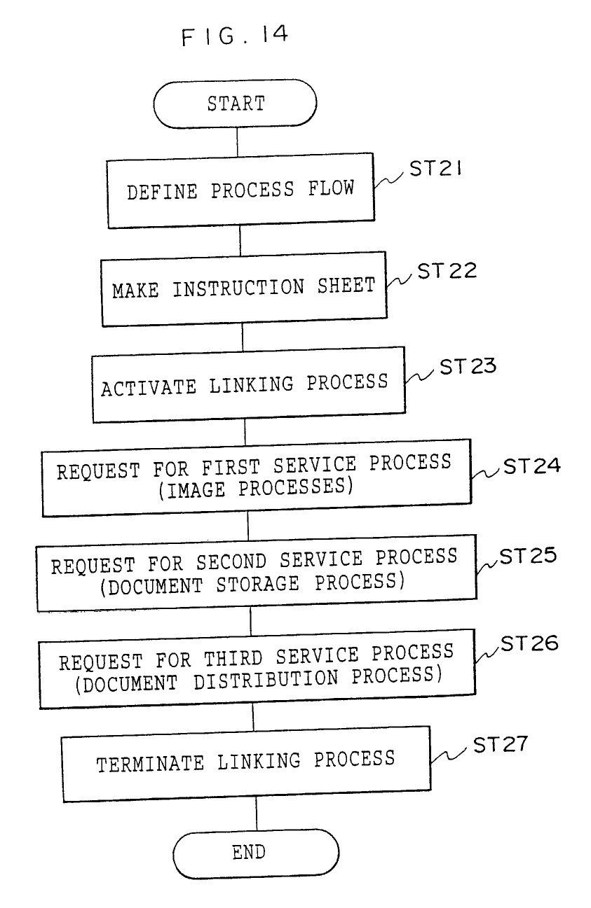

FIG. 14 is a flowchart showing steps of linkage processing of the document processing system 201.

(Process Flow Definition Process)

In step ST21, the client terminal 210 accesses, via a browser installed through user operations, a URL (uniform resource locator) for the HTML file generated for the user interface screen provided by the Web server section 232 of the instruction sheet making server 230. In response to a viewing request, the Web server section 232 transmits the HTML file for the user interface screen to the client terminal 210. The HTML file is displayed on the client terminal 210 through the browser. The user uses the user interface screen and thereby defines a service-linkage process flow (workflow). Information regarding the defined service-linkage process flow is transmitted to the Web server section 232 of the instruction sheet making server 230. The instruction sheet making server 230 outputs the instruction sheet in the form of an XML file. The instruction sheet management section 241 of the instruction sheet management server 240 stores the instruction sheet transmitted from the instruction sheet making server 230.

(Instruction sheet Making Process)

In step ST22, the instruction sheet making server 230 makes an instruction sheet on the basis of information regarding the service-linkage process flow, which has been received by the Web server section 232 transmitted from the client terminal 210, and information such as I/F information regarding the individual services being managed by the service information management section 231. The instruction sheet thus made includes the definitions of information for specifying a document selected as a processing object. The aforementioned information includes, for example, the contents of processes that are requested to the individual services, input parameters, a linkage method (workflow) for the individual services, a document name, and storage-location information.

(Invocation of Linkage Process)

In step ST23, the client terminal 210 accesses the instruction sheet management server 240 and acquires a list of instruction being managed by the instruction sheet management server 240. The client terminal 210 acquires a desired service linkage process from a service-linkage process selection screen such as the screen shown in FIG. 8, and performs instruction processes therefor. The instruction sheet management server 240 transmits to the linking processing server 250 an instruction sheet corresponding to service-linkage-process selected information received from the client terminal 210.

(First Service Process Request)

In step ST24, the linking processing server 250 interprets the instruction sheet that defines the overall process flow transmitted from the instruction sheet management server 240, and issues a process request to the image processing device 261 described in the instruction sheet to perform the first service process. On the basis of information included in the instruction sheet, the linking processing server 250 extracts, for example, location information of the service processing device to which the process request is issued, input parameters and output parameter formats that are necessary for the process request, a method name for the process request, an invocation scheme, and information specifying a processing-objective document. Then, the linking processing server 250 makes an instruction sheet (discrete instruction sheet) for the first service process request. Thereafter, the linking processing server 250 transmits the discrete instruction sheet thus made to the image processing device 261 specified as a first process request destination.

On the basis of location information of a storage area for the processing-objective document described in the transmitted instruction sheet, the image processing device 261 copies the processing-objective document, thereby acquiring the document. For the acquired document image, the image processing device 261 interprets the service-process request content, performs an image process including, for example, a noise erasing process and an OCR process, and re-store a document formed by binding the acquired image document and a text document into an original storage area. Upon completion of the process, the image processing device 261 transmits the processing result to the linking processing server 250. The processing result includes, for example, state information of the process (completed), output parameters, and information of a postprocess document storage area.

(Second Service Process Request)

In step ST25, upon receipt of the processing result from the first service process (image processes), the linking processing server 250 manages the first process request result in the form of a log. Then, on the basis of the instruction sheet containing definitions of the overall process flow, the linking processing server 250 specifies a second process request destination, and issues a process request to the document management server 262 assigned to perform the second service process. As in the first service process request, the linking processing server 250 transmits to the document management server 262 discrete instruction information such as information declaring that a document containing information regarding the process request is to be stored, a document storage area, and information specifying the processing-objective document.

On the basis of the storage area information included in the content of the request, the document management server 262 performs a storage process for the document that has been processed and stored in the previous process (first service process) on the basis of the content of the request of the linking processing server 250. Upon completion of the process, the document management server 262 transmits the processing result to the linking processing server 250. The result of the processes includes, for example, state information of the process (completed), output parameters, and information of a postprocess document storage area.

(Third Service Process Request)

In step ST26, upon receipt of the processing result from the second service process (document storage process), the linking processing server 250 manages the second process request result in the form of a log. Then, on the basis of the instruction sheet containing the definition of the overall process flow, the linking processing server 250 specifies a third process request destination, and issues a process request to the document distribution server 263 assigned to perform the third service process. As in the second service process request, the linking processing server 250 transmits to the document distribution server 263 discrete instruction information such as information declaring that a document containing information regarding the process request is to be stored, a document storage area, and information specifying the processing-objective document.

On the basis of the document-specifying information (storage area information), the document distribution server 263 reads out a document file and performs processing described in the content of the request for the document that has been processed and stored in the previous process (second service process) on the basis of the content of the request of the linking processing server 250. In the document formed by binding the text document and the image document, the document distribution server 263 transmits only the text document by mail to a mail address specified as a distribution destination, and transmits only the image document by facsimile to a specified facsimile number. Upon completion of the process, the document management server 263 transmits the processing result to the linking processing server 250. The processing result includes, for example, state information of the process (completed), output parameters, and information of a postprocess document storage area. For example, when performing the facsimile transmission process, suppose the line of the destination is busy, and a predetermined number of retries fail in communication to the destination. In this case, the document distribution server 263 transmits message “mail transmission: completed; facsimile transmission: not yet completed” as state information to the linking processing server 250.

(Termination of Linkage Process)

In step ST27, the linking processing server 250 receives the result of the third service process. When having determined that a subsequent process described in the instruction sheet, which defines the overall process flow, does not follow, the linking processing server 250 posts a completion notification of all the processes to the client terminal 210. Thus, the total process terminates.

The linking processing server 250 is not only capable of determining the processing content of the second service process, but also capable of determining the content of subsequent processes depending on the necessity on the basis of the result of the first service process.

In addition, upon receipt of the processing result of the service process request, the linking processing server 250 is capable of implementing processes on the basis of the process state of each of services. As described in connection with step ST26, suppose the linking processing server 250 has received state information with message “mail transmission: completed; facsimile transmission: not yet completed” as a result of the first service process request. In this case, the linking processing server 250 is capable of issuing the process request to the subsequent second service and, in addition, again issuing a request to the first service only for execution of the facsimile transmission process.

In addition, on the basis of descriptions in the instruction sheet, the linking processing server 250 is capable of controlling condition-branching process corresponding to the result of the first service process. The linking processing server 250 is capable of implementing processes such that if a document approval process is, for example, “approved” as a result of the first processing result, a process request is issued to the second process; whereas if the approval process is “not approved”, a process request is issued to the third process.

Further, in a case where results of the first service process and the second service process have satisfied predetermined conditions on the basis of descriptions of the instruction sheet, the linking processing server 250 is capable of controlling merging of processes performed for issuing a third process request. For example, a case is assumed for performing a first document approval process (first service process) for an administration department in a company organization and a second document approval process (second service process) for a personnel department in the company organization. In this case, the linking processing server 250 is capable of performing control for the processing of issuing a third process request when the documents have been approved and the two approved documents become ready therefor.

Thus, the linking processing server 250 acquires an instruction sheet containing descriptions of each of the services and interprets the instruction sheet. Thereby, the linking processing server 250 sequentially issues process requests to the individual services, and manages a linkage process for the individual services. Consequently, a user who desires the linkage process to be executed can cause the individual processes to be linked and appropriately automatically executed simply by specifying the execution of the linkage process.

In addition, in the linking processing server 250, since flow control is managed for a linkage process for services in a workflow, flow control with a higher level and flexibility can be implemented when individual processes are linked and processed.

Further, in the linking processing server 250, integrated information (I/F information) is used to issue instructions to individual services. Thereby, a linkage process can be defined and executed independently of software modules and hardware.

The instruction sheet making server 230 generates an instruction sheet from information related to a process configured by linking functions that are implemented with software products distributed over the network and functions that are implemented with hardware. On the basis of the instruction sheet, the linking processing server 250 requests individual services for execution of processes and manages a linked process flow. Thereby, without performing compacted operations, a user can cause the linkage process for the individual services to be executed.

A user provides definitions of a linkage process for individual services through the GUI 211. On the basis of the definitions in the GUI 211, the instruction sheet making server 230 generates an instruction sheet. On the basis of the instruction sheet generated by the 230, the linking processing server 250 appropriately controls the processes. Consequently, the user is able to easily make various process flows.

What is claimed is:

1. A linking processing device comprising:
a receiver that receives instruction information comprising a control content for linking and performing processing, on a network, of a plurality of services that each perform predetermined process of document data; and
a controller that issues a request to each of the services for processing a document as a processing object, on the basis of the control content contained in the instruction information received by the receiver.

2. A linking processing method comprising the steps of:
receiving instruction information comprising a control content for linking and performing processing, on a network, of a plurality of services that each perform predetermined process of document; and
issuing a request to each of the services for processing a document as a processing object, on the basis of the control content contained in the received instruction information.

3. A linking processing device for linking and processing, on a network, services that each perform predetermined process of document data, the device comprising:
first transmitting means that transmits first instruction information specifying a processing object and a first processing content for the processing object, to a first service processing device;
receiving means that receives a processing result of processing performed by the first service processing device and second instruction information specifying the processing object processed by the first service processing device; and
second transmitting means that transmits the second instruction information and a second processing content to a second service processing device.

4. A linking processing device according to claim 3, wherein the first instruction information and the second instruction information comprise document information, or a storage location for the document and a method of acquiring the document.

5. A linking processing device according to claim 3, further comprising first determining means that determines the second processing content on the basis of the processing result received by the receiving means.

6. A linking processing device according to claim 3, further comprising second determining means that determines the second processing content that is processed by the second service processing device and a third processing content that is processed by a third service processing device that subsequently performs processing, on the basis of the processing result received by the receiving means.

7. A linking processing device according to claim 3, further comprising third determining means that determines a third processing content that is processed by a third service processing device, on the basis of the processing result received by the receiving means and a processing result of processing performed by the second service processing device.

8. A linking processing method for linking and processing, on a network, services that each perform predetermined process of document data, the method comprising:
a first transmitting step for transmitting first instruction information specifying a processing object and a first processing content for the processing object, to a first service processing device;
a receiving step for receiving a processing result of processing performed by the first service processing device and second instruction information specifying the processing object processed by the first service processing device; and
a second transmitting step for transmitting the second instruction information and a second processing content to a second service processing device.

9. A linking processing method according to claim 8, wherein the first instruction information and the second instruction information comprise document information, or a storage location for the document and a method of acquiring the document.

10. A linking processing method according to claim 8, further comprising a first determining step for determining the second processing content on the basis of the processing result received in the receiving step.

11. A linking processing method according to claim 8, further comprising a second determining step for determining the second processing content that is processed by the second service processing device and a third processing content that is processed by a third service processing device that subsequently performs processing, on the basis of the processing result received in the receiving step.

12. A linking processing method according to claim 8, further comprising a third determining step for determining a third processing content that is processed by a third service processing device, on the basis of the processing result received in the receiving step and a processing result of processing performed by the second service processing device.

13. A recording medium containing a linking processing program for linking and processing, on a network, services that each perform predetermined process of document data, wherein the linking processing program directs a computer to execute processing comprising:
a first transmitting step for transmitting first instruction information specifying a processing object and a first processing content for the processing object, to a first service processing device;
a receiving step for receiving a processing result of processing performed by the first service processing device and second instruction information specifying the processing object processed by the first service processing device; and
a second transmitting step for transmitting the second instruction information and a second processing content to a second service processing device.

14. A recording medium containing a linking processing program according to claim 13, wherein the first instruction information and the second instruction information comprise document information, or a storage location for the document and a method of acquiring the document.

15. A recording medium containing a linking processing program according to claim 13, wherein
the linking processing program directs a computer to execute processing further comprising a first determining step for determining the second processing content on the basis of the processing result received in the receiving step.

16. A recording medium containing a linking processing program according to claim 13, wherein
the linking processing program directs a computer to execute processing further comprising a second determining step for determining the second processing content that is processed by the second service processing device and a third processing content that is processed by a third service processing device that subsequently performs processing, on the basis of the processing result received in the receiving step.

17. A recording medium containing a linking processing program according to claim 13, wherein the linking processing program directs a computer to execute processing further comprising a third determining step for determining a third processing content that is processed by a third service processing device, on the basis of the processing result received in the receiving step and a processing result of processing performed by the second service processing device.

18. A linking processing device comprising:
a controller that generates discrete instruction information comprising at least one of instruction information for document data and processing-related information therefor with respect to a service whose turn in a linkage process has arrived, on the basis of linkage instruction information instructing linking and processing, on a network, of a plurality of services that each perform predetermined process of document data;
a transmitter that transmits the discrete instruction information to a service processing device that carries out the service in its turn for the linkage process; and
a receiver that receives the instruction information for the document data processed by the service processing device and a processing result of processing performed by the service processing device.

19. A linking processing device according to claim 18, wherein the controller generates the discrete instruction information, on the basis of at least one processing result received by the receiver, for at least one service whose turn in the linkage process comes next or thereafter.

20. A linking processing device according to claim 18, wherein
the controller determines a subsequent service and generates the discrete instruction information for the determined service on the basis of linkage processing information including condition-branching linkage processing, and at least one processing result received by the receiver.

21. A linking processing device according to claim 18, wherein the instruction information for the document data is information representing a storage location for the document data or a method of acquiring the document data.

22. A recording medium containing a linking processing program that directs a computer to execute the process comprising:
generating discrete instruction information comprising at least one of instruction information for document data and processing-related information therefor with respect to a service whose turn in a linkage process has arrived, on the basis of linkage instruction information instructing linking and processing, on a network, of a plurality of services that each perform predetermined process of document data;
transmitting the discrete instruction information to a service processing device that carries out the service in its turn for the linkage process; and
receiving the instruction information for the document data processed by the service processing device and a processing result of processing performed by the service processing device.

23. A recording medium containing a linking processing program according to claim 22, wherein the linking processing program directs a computer to execute the processing of generating the discrete instruction information, on the basis of at least one received processing result, for at least one service whose turn in the linkage process comes next or thereafter.

24. A recording medium containing a linking processing program according to claim 22, wherein the linking processing program directs the computer to further execute the processing of determining a subsequent service and generates the discrete instruction information for the determined service on the basis of linkage processing information including condition-branching linkage processing, and at least one received processing result.

25. A recording medium containing a linking processing program according to claim 22, wherein
the instruction information for the document data is information representing a storage location for the document data or a method of acquiring the document data.
